(19) United States
(12) Patent Application Publication
(10) Pub. No.: US 2025/0354638 A1
(43) Pub. Date: Nov. 20, 2025

(54) COUPLING DEVICE FOR A TUBE

(71) Applicant: A. Raymond et Cie, Grenoble (FR)

(72) Inventors: Kévin Guibert, Grenoble (FR); Titus Turlot, Grenoble (FR)

(21) Appl. No.: 19/210,290

(22) Filed: May 16, 2025

(30) Foreign Application Priority Data
May 17, 2024 (FR) 2405094

(51) Int. Cl. F16L 37/091

(52) U.S. Cl. CPC F16L 37/091; F16L 2201/10

(57) ABSTRACT

A coupling device is provided with an indicator of good connection. In particular, the indicator is a sound emission means, more particularly a whistle, which, when activated reveals a connection fault, and, in particular, a leak, in the connection. The proposed arrangement also uses cleanliness means configured to limit, or even prevent, the entry of dust into the coupling device. In order to effectively combine the sound emission means and cleanliness means, one or more escape paths are provided that bypass the cleanliness means.

### PRIORITY CLAIM

This application claims the benefit of the filing date of French Patent Application Serial No. FR2405094, filed May 17, 2024, for “Coupling Device for a Tube,” the disclosure of which is hereby incorporated herein in its entirety by this reference.

### TECHNICAL FIELD

The present disclosure relates to the field of fluid coupling devices implemented in fluid circulation and/or distribution systems.

More particularly, the present disclosure relates to a device for coupling a tube, provided with means making it possible to verify the correct state of connection of the tube to the coupling device.

### BACKGROUND

Today, fluid coupling devices are widely used in motor vehicles and road transport vehicles. These fluid coupling devices are, in particular, implemented to ensure the circulation and/or distribution of a fluid within these vehicles.

Furthermore, in order to ensure assembly rates compatible with the requirements of the automotive and/or road transport vehicle industries, it may be necessary to have fluid coupling devices enabling quick connections and means for verifying their assembly.

In this respect, document [1] cited at the end of the description discloses a coupling device enabling the fluid connection of a tube or duct, which comprises a visual mounting indicator.

In particular, this coupling device comprises a hollow body that is substantially cylindrical and has a receiving housing opening onto an insertion opening. A locking ring as well as a seal are also provided in the receiving housing and arranged to secure a tube inserted into the receiving housing through the insertion opening and along an insertion direction.

The coupling device also comprises a cartridge capable of being locked in either a first or a second position in the receiving housing. The cartridge initially locked in the first position partially protrudes from the receiving housing through the insertion opening. The insertion of a predetermined length into the receiving housing, along the insertion direction, allows the cartridge to be unlocked and slid from the first position to the second position wherein the cartridge is fully integrated into the receiving housing.

The complete insertion of the cartridge into the receiving housing makes it possible to conclude that the tube is properly connected with the coupling device. However, there are situations for which the conditions of illumination and/or the cramped conditions of the coupling areas on the vehicles prevent the observation of the position of the cartridge and thus make the function of visual control of the cartridge inefficient.

Alternatively, the coupling device may be provided with an audible indicator. Document [2] cited at the end of the description discloses an example of such a device. In particular, the coupling device described in this document comprises an audible indicator formed by an elastic pin configured to jiggle once a predetermined length of the tube is pushed into the coupling device. However, a noisy environment makes sound detection difficult.

Again alternatively, document [3] cited at the end of the description discloses a coupling device that proposes an arrangement of exhaust lines. Notably, these exhaust lines are arranged, in the event of a fluid leak, to guide the fluid outwardly, and the fluid flow in the exhaust lines generates a sound wave.

The coupling devices presented in these documents do not, however, limit the entry of dust and other contaminants into the device.

Thus, one aim of the present disclosure is therefore to propose a coupling device provided with a good connection indicator and for which the entry of dust and other contaminants remains limited.

Another aim of the present disclosure is to propose a coupling device that remains simple and ergonomic to use.

### BRIEF SUMMARY

With a view to achieving these aims, at least in part, the object of the present disclosure proposes a coupling device for a tube comprising:
a main body defining a rotationally symmetrical housing provided with an opening for inserting a tube along an insertion direction, the housing being delimited by an inner surface and comprising a first shoulder forming a widening of the housing along the insertion direction; and
a retaining ring, which is at least partially inserted into the housing through the opening and which comprises, along the direction of insertion, a base, for example, a circular base, and a rotationally symmetrical retaining portion having a diameter less than the extent of the base, the retaining portion having on its side surface a snap-fit collar which is configured to enable the retaining ring to remain clipped in the housing by way of the collar engaging with the first shoulder, the retaining ring defining a channel by which the tube is intended to be inserted into the housing.

The retaining ring is mounted in the housing with axial play that is not zero in order to adopt either a first position or a second position, the first position requiring the collar to bear against a first shoulder in a direction opposite to the direction of insertion, and the second position requiring the base to bear, along the direction of insertion, against an abutment means formed on the main body. Escape paths are also provided in the space formed between the side surface and the inner surface, and the escape paths are arranged to allow a fluid which may be present in the chamber downstream of the retaining ring to escape outwardly when the ring, under the effect of a pressure which may be exerted by the fluid, is in its first position. The escape paths are provided so that the flow of the fluid in the escape paths generates the emission of a sound wave.

According to one embodiment, the escape paths comprise one or more holes formed in the snap-fit collar.

According to one embodiment, the escape paths comprise one or more notches formed on an outer contour of the snap-fit collar.

According to one embodiment, the exhaust paths comprise longitudinal grooves formed on the inner surface.

According to one embodiment, the coupling device further comprises a guide provided with a sleeve that extends from a free end in the direction of insertion, and which is configured to guide the tube during the insertion of the tube into the housing.

According to one embodiment, the coupling device comprises locking means arranged downstream of the retaining ring in the housing and configured to engage with a tube inserted in the housing.

According to one embodiment, the locking means comprises a ring, known as a locking ring.

According to one embodiment, a seal is arranged in the housing downstream of the locking means, the seal is configured to provide a seal between the inner surface and a side surface of the tube, which is insertable into the housing.

According to one embodiment, a cleanliness seal is arranged in the channel. The cleanliness seal is configured to allow the removal of dirt and/or dust that may be present on a side surface of the tube when the tube is inserted into the housing. Advantageously the cleanliness seal is also configured to provide a seal between an inner surface of the retaining portion and the side surface of the tube, which is insertable into the housing so as to prevent any escape of fluid that may be present in the chamber downstream of the retaining ring when the ring, under the effect of a pressure that may be exerted by the fluid, is in its first position.

According to one embodiment, the base is configured to limit or even prevent dust from entering the housing when the base bears against the abutment means.

According to one embodiment, the abutment means are formed by an edge of the main body delimiting the opening of the housing.

According to one embodiment, the abutment means are formed by a second shoulder formed on the inner surface.

The present disclosure also relates to a method for coupling a tube with a female element by way of the coupling device according to the present disclosure, the method comprising the execution of the following steps:
coupling the coupling device with a female element; and
coupling a tube with the coupling device, the coupling comprising the insertion of the tube into the housing along the direction of insertion via the ring.

The method further comprises the selection of a coupling device for which the exhaust path(s) allow an audible signal to be emitted when a fluid leak occurs.

According to one embodiment, the exhaust path(s) is/are dimensioned to emit an audible signal having an intensity greater than 80 dB in the event of a fluid leak.

### BRIEF DESCRIPTION OF THE DRAWINGS

Other features and advantages of the present disclosure will become apparent from the following detailed description of embodiments of the present disclosure with reference to the accompanying figures, in which:

FIG. 1 is a schematic depiction of a coupling device according to one example embodiment of the present disclosure, notably, FIG. 1 depicts the coupling device according to a cross-sectional plane passing through the main axis AA′ of the coupling device;

FIG. 2 is a schematic depiction of the main body implemented in the example of FIG. 1 and according to a cross-sectional plane passing through the main axis AA′ of the coupling device;

FIG. 3 is a schematic depiction of the retaining ring implemented in the example of FIG. 1 and according to a cross-sectional plane passing through the main axis AA′ of the coupling device;

FIG. 4 is a schematic depiction of the retaining ring shown in FIG. 3 and bearing a cleanliness seal;

FIG. 5 is a schematic and partial depiction of the retaining ring mounted on the main body, with the retaining ring in the first position, along a cross-sectional plane passing through the main axis AA′;

FIG. 6 is a schematic and partial depiction of the retaining ring mounted on the main body, with the retaining ring in the second position, along a cross-sectional plane passing through the main axis AA′;

FIG. 7 is a partial schematic depiction of a tube mounted in the coupling device, the tube having a beveled free end, along a cross-sectional plane passing through the main axis AA′;

FIG. 8 is a schematic depiction of the retaining ring implemented in the example shown in FIG. 1, and which comprises a large notch;

FIG. 9 is a schematic depiction of the retaining ring implemented in the example shown in FIG. 1, and which comprises small notches;

FIG. 10 is a schematic depiction of the retaining ring implemented in the example shown in FIG. 1, and which comprises holes passing through the snap-fit collar along direction AA′;

FIG. 11 is a schematic depiction of the retaining ring implemented in the example shown in FIG. 1, and which comprises a hole passing through the snap-fit collar along a radial direction (FIG. 11);

FIG. 12 is a schematic representation of the main body implemented in the example shown in FIG. 1, which comprises grooves formed on its inner surface;

FIG. 13 is a schematic depiction of the main body and of a retaining ring, the ring being in abutment against a second shoulder formed on the inner surface of the main body.

### DETAILED DESCRIPTION

The present disclosure relates to a coupling device provided with an indicator of good connection. In particular, the indicator in question is a sound emission means, more particularly, a whistle, which, when activated reveals a connection fault, and, in particular, a leak, in the connection. The proposed arrangement also uses cleanliness means configured to limit, or even prevent, the entry of dust into the coupling device. In order to effectively combine the sound emission means and cleanliness means, the present disclosure proposes to provide one or more escape paths, which bypass the cleanliness means.

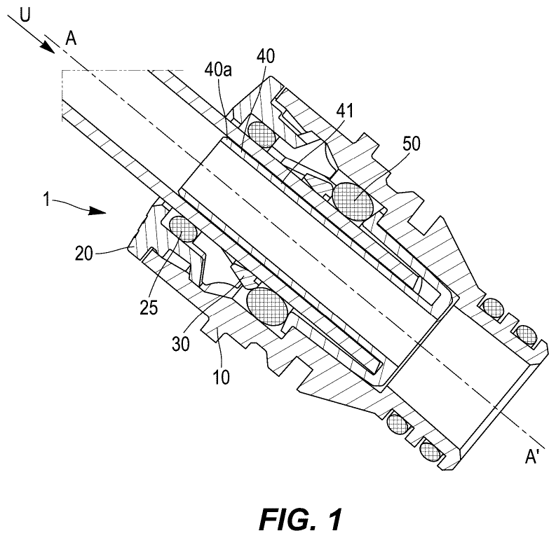

FIG. 1 is an illustration, along a longitudinal cross-sectional plane, of a coupling device that may be considered within the scope of the present disclosure.

“Longitudinal cross-sectional plane” refers to the intersection between the coupling device and a plane passing through an elongation axis of the device.

The principles set out below are not limited just to the arrangement shown in this example. In particular, a person skilled in the art, based on what follows, could consider other configurations.

Notably, the coupling device 1 comprises a main body 10, a retaining ring 20, a locking means 30, optionally a guide 40, a seal 50 (for example, an O-ring).

The main body 10 is elongated along a main axis AA′, and extends notably from one end 10a to another end 10b.

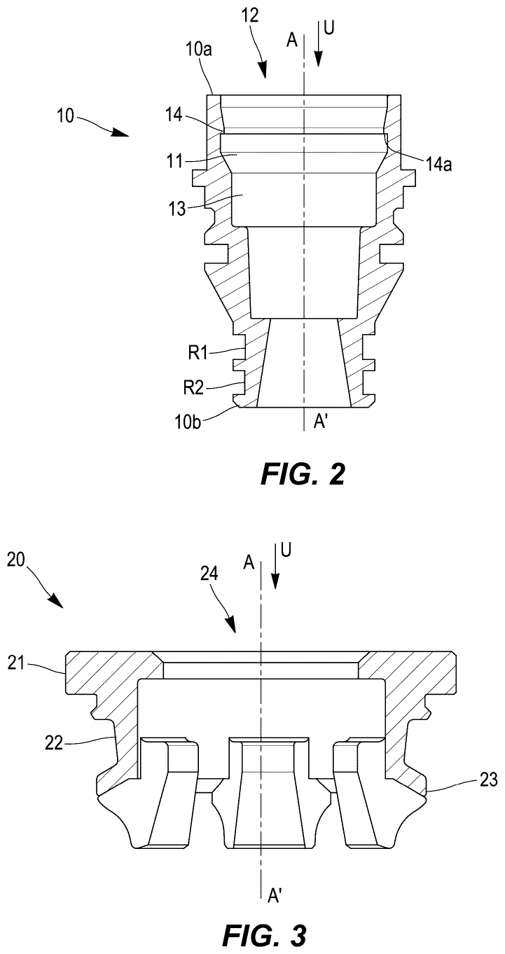

The main body 10 defines a housing 11 with an opening 12 at the end 10a (FIG. 2). The opening 12 notably allows the insertion of a tube along an insertion direction “U” in the direction defined by the main axis AA′. The housing 12 is delimited by an inner surface 13 of the main body 10 and which has a rotational symmetry about the main axis AA′.

The outer surface of the main body 10 may comprise one or more circumferential grooves R1, R2 intended to receive one or more O-rings making it possible to ensure a sealed junction with a female element.

The main body 10 also comprises a first shoulder forming a widening of the inner surface along the direction of insertion. In this respect, the first shoulder can be formed by a circumferential stop 14 formed on the inner surface 13. This circumferential stop 14 may notably comprise a circumferential rib formed on the inner surface and having rotational symmetry. More particularly, the circumferential rib may comprise an annular surface 14a forming the stop along a direction opposite to the direction of insertion “U.” It is understood, without it needing to be specified, that the annular surface 14a forms a shoulder, and notably a shoulder leading to an increase in the diameter of the inner surface along the direction of insertion “U.”

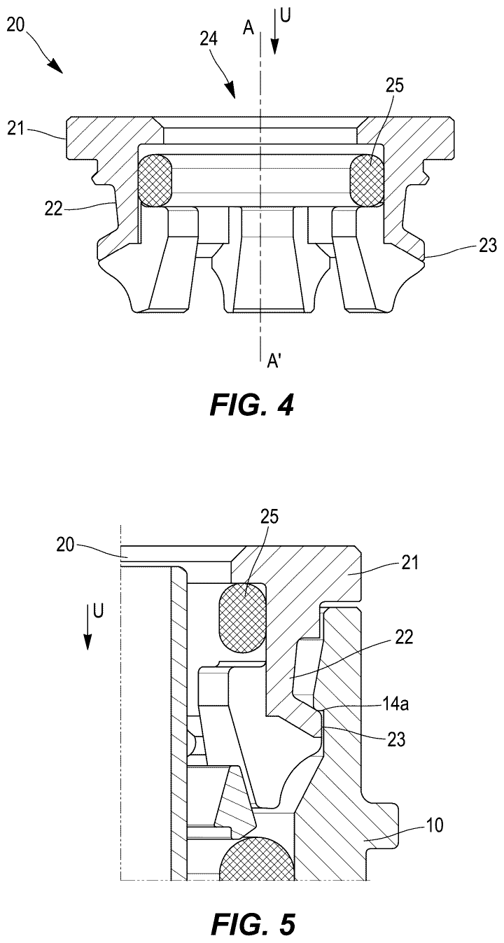

FIG. 3 and FIG. 4 are depictions of the retaining ring 20. More particularly, FIG. 3 depicts the retaining ring 20 in isolation, while FIG. 4 depicts the retaining ring 20 on which a cleanliness seal 25 is mounted, as described in further detail below. The retaining ring 20, as shown in FIG. 1, is intended to be at least partially inserted into the housing 11 through the opening 12. Notably, the retaining ring 20 comprises, along the direction of insertion “U,” a base 21, for example, a circular base, and a retaining portion 22, which extends from the circular base 21. Both the base 21 and the retaining portion 22 can be rotationally symmetrical.

In addition, the retaining portion 22 has a diameter less than the extent of the base 21. In other words, if the base 21 is circular, the diameter of the base 21 is greater than the diameter of the retaining portion 22.

The retaining portion 22 is provided, on its side surface, with a snap-fit collar 23 configured to allow the retaining ring to be held in snap-fit engagement in the housing. Notably, and as shown in FIG. 1, maintaining the snap-fit engagement involves cooperation between the snap-fit collar 23 and the annular surface 14a.

The retaining ring 20 defines a channel 24 through which a tube is intended to be inserted into the housing 11. It is understood, without it needing to be specified, that the channel 24 extends coaxially to the housing.

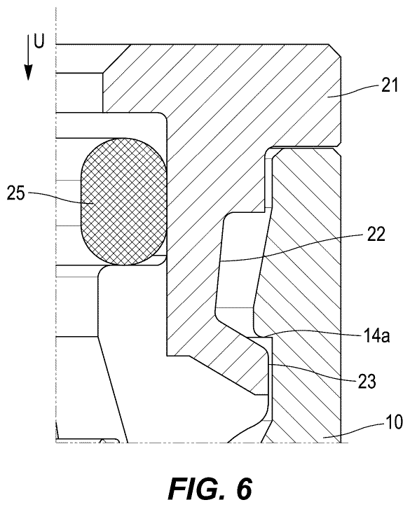

In addition, and as shown in FIG. 5 and FIG. 6, the retaining ring 20 is mounted in the housing 11 with non-zero axial play (axial play means play along the main axis AA′). Notably, this play allows the retaining ring to adopt either a first position or a second position, for example, by displacement along direction AA′.

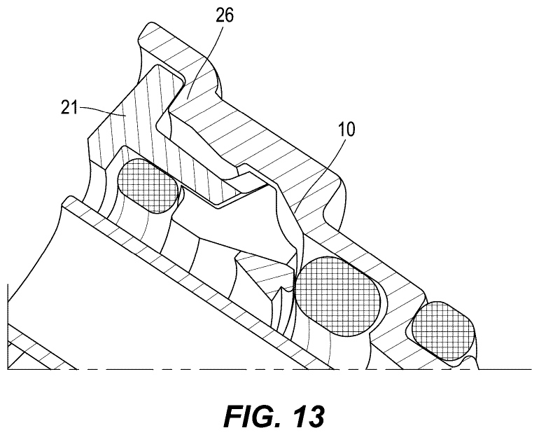

In this respect, the first position is a position requiring the snap-fit collar 23 to bear against the first shoulder (and notably against the annular surface 14a) along a direction opposite to the insertion direction (FIG. 5). The second position is a position in which the base 21 rests, along the direction of insertion, against an abutment means formed on the main body (FIG. 6). Notably, and as shown in FIG. 6, the abutment means can be formed by an edge of the main body delimiting the opening 12. Alternatively, the abutment means may comprise a second shoulder 26 formed in the housing (FIG. 13). The latter configuration better limits the entry of particles and other contaminants into the housing.

According to the present disclosure, the retaining ring 20 can be provided with a cleanliness seal 25. More particularly, the cleanliness seal 25 can be mounted in the channel 24 of the retaining ring, and notably retained in a groove in the channel 24.

As shown in FIG. 1, the locking means 30 is arranged downstream of the retaining ring 20 in the housing 11 and intended to engage with a tube inserted in the housing. A locking means is notably described in document [4] cited at the end of the description. Notably, this document describes the implementation of a locking ring, which can be associated with the locking means according to the terms of the present disclosure.

Particularly advantageously, the locking means comprises a ring, known as a locking ring, for securing a tube that can be inserted into the housing along the direction of insertion “U.” More particularly, the locking ring is arranged to prevent the extraction of the tube when the tube is inserted into the housing 11 and is engaged with the locking ring.

In this respect, the locking ring can be provided with attachment means allowing it to be engaged with the tube. More particularly, the locking ring may have a tapered inner cross-section making it possible to grip the outer surface of the tube, and thus be engaged with the tube.

“Engaged” is understood to mean two elements mechanically secured to one another. The expression “engaged” also has a reciprocal nature such that a first element engaged with a second element implies that the second element is engaged with the first element. Thus, and throughout the description, once the locking ring is engaged with the tube, the tube is engaged with the locking ring.

The retaining ring, arranged upstream of the locking ring along the direction of insertion “U,” constitutes an obstacle against which the locking ring is likely to abut when it engages with the tube and when a removal force along a direction opposite to the direction of insertion is exerted on the tube. In other words, an extraction force, along an extraction direction (opposite to the direction of insertion U), on a tube with which the locking ring is engaged, will position the latter in abutment against the retaining ring and thus prevent the removal of the tube.

The coupling device 1 according to the present disclosure also comprises a guide 40.

In particular, the guide 40 comprises a sleeve 41, which extends from a free end 40a along the insertion direction U and coaxial to the channel 24.

More particularly, the sleeve 41 has an outer diameter less than that of the channel, and notably less than the inner diameter of the tube. This last aspect thus enables the sleeve to be inserted into the tube when the tube is positioned in the coupling device 1. In other words, the sleeve 41 guides the tube into the housing 11.

Still in accordance with the present disclosure, the seal 50 is arranged in the housing downstream of the locking means along the direction of insertion.

Thus, during operation, a tube 60 can be inserted into the channel 24 along the direction of insertion “U.” During its insertion, the outer surface of the tube 60 is in contact with the cleanliness seal 25, which, by rubbing against the surface, retains any impurities that may be present on the outer surface, while the sleeve penetrates (or fits) into the tube for guiding purposes. The cleanliness seal also provides a seal between an inner wall of the channel and the outer surface of the tube 60.

As it is inserted, the tube successively encounters the locking means, then the seal 50. The locking means is notably configured so that, when it is in contact with the outer surface of the tube, it resists withdrawal of the latter from the housing. The seal 50 is configured to provide a seal between the inner surface and a side surface of the tube that can be inserted into the housing 11.

Thus, as soon as a pressurized fluid flows through the tube-coupling device assembly, the locking ring can be seen to move backwards (moving in the opposite direction to the direction of insertion), which comes into abutment against the retaining ring and notably at a free end of the retaining portion 22. This latter movement has the effect of pressing the snap-fit collar 23 and the annular surface 14a together.

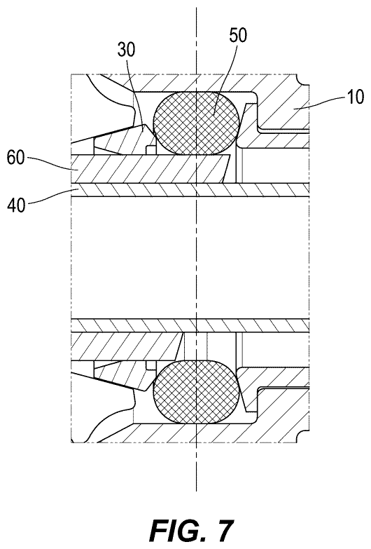

There are also situations in which the tube is not tightly fitted in the housing. Such situations can notably arise when the seal is not properly, or evenly, compressed between the inner surface of the housing and the outer surface of the tube. For example, defects on the outer surface of the tube, or else the presence of impurities, can alter the tightness of the assembly and lead to a pressurized fluid leak. Alternatively, a free end of the tube with too pronounced a bevel (marked with an arrow on FIG. 7) can limit the contact between the outer surface of the tube and the seal, and thus generate a leakage path of pressurized fluid.

Thus, if the assembly is not sealed, pressurized fluid can only escape outwardly through the space between the main body and the retaining ring (indeed, as previously mentioned, the cleanliness seal prevents any fluid from flowing into the space between the inner surface of the channel and the outer surface of the tube).

Thus, the present disclosure provides for the implementation of one or more exhaust paths in the space formed between the side surface of the retaining ring and the inner surface of the housing. Notably, this or these exhaust path(s) are arranged to allow the escape, outwardly, of a fluid likely to be present in the chamber downstream of the retaining ring when the retaining ring, under the effect of a pressure likely to be exerted by the fluid, is in its first position.

Notably, and according to the present disclosure, the exhaust path or paths are arranged so that the flow of the fluid in the exhaust paths generates the emission of a sound wave, and more particularly a sound wave with an energy at least equal to 80 Decibels.

Such a sound wave can notably be obtained by creating a passage for the pressurized fluid allowing a sufficiently large flow rate to decompress the pressurized fluid so as to generate a sound wave.

The dimensioning of exhaust paths follows the laws of pneumatics (the pressure ratio and the flow cross-section limit the flow rate) and acoustics (the power of the sound wave is notably linked to the leakage flow rate and the hearing distance), and the skilled person will be fully able to select appropriate dimensions for the exhaust paths on reading the following.

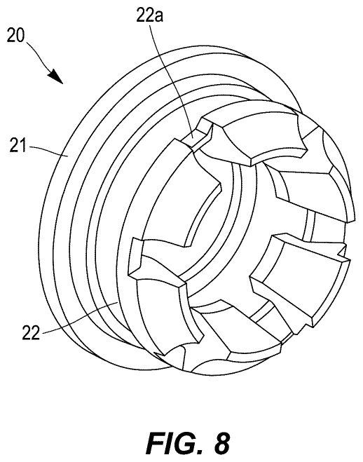

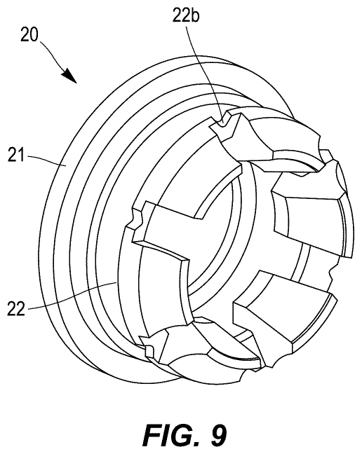

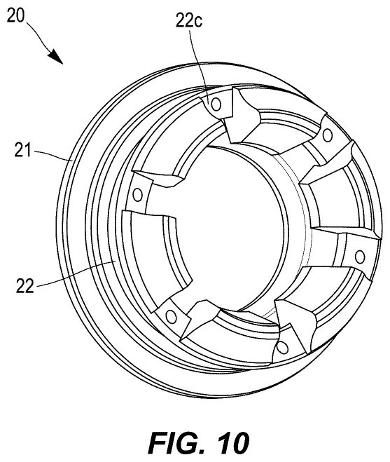

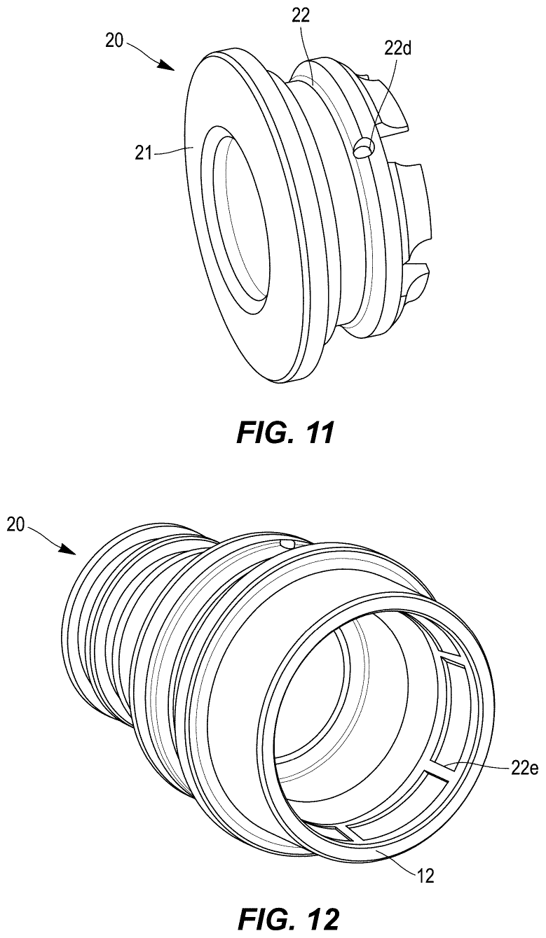

Thus, FIG. 8, FIG. 9, FIG. 10 and FIG. 11 show four example embodiments of exhaust paths. Notably, FIG. 8 and FIG. 9 implement a large notch 22a (FIG. 8) and small notches 22b (FIG. 9) formed on an outer contour of the snap-fit collar. FIG. 10 and FIG. 11 implement holes 22c and 22d passing through the snap-fit collar along direction AA′ (FIG. 10) and along a radial direction (FIG. 11).

Alternatively, grooves 22e (oriented along direction AA′) may be considered on the inner surface of the main body providing escape paths between the inner surface of the body and the outer surface of the retaining ring (FIG. 11).

The coupling device according to the present disclosure thus offers a combination of exhaust paths and a retaining ring that limits, or even prevents, particles from entering the housing. The exhaust path(s) also bypass(es) the retaining ring, and are also dimensioned so that a sound wave is emitted when they are traversed by a pressurized fluid. Finally, the assembly play of the retaining ring compensates for dimensional tolerances between the ring and the main body.

The inventors were able to test the effectiveness of the exhaust paths in revealing the presence of a leak by emitting a sound wave.

Notably, the inventors were initially able to observe that in the absence of an exhaust path, no whistling (or sound wave emission) is detectable in the presence of a leak.

However, if the retaining ring comprises one or more holes, and/or one or more notches formed in the snap-fit collar, a whistling sound with an intensity greater than 80 dB is detected when the assembly is leaky. Notably, a whistling sound with an intensity of 90 dB was measured for an assembly subjected to an air pressure equal to 12 bar. The present disclosure thus enables leak detection in a noisy environment.

Advantageously, the exhaust paths can have a cumulative cross-section greater than or equal to 1.5 mm². This cross-section detects leaks by emitting an audible signal when the pressure of the fluid in question is around 12 bar.

The term “cross-section of the exhaust path(s)” means the cross-sectional surface area of the exhaust path.

It is understood that temperature, pressure or even expected noise levels may require redimensioning of the exhaust paths (and notably their cross-section). These latter aspects are within the grasp of the skilled person who, on the basis of their general knowledge in the fields of thermodynamics and acoustics, will be able to dimension the exhaust paths and notably the notches and/or holes, according to the conditions imposed.

The present disclosure also relates to a method for coupling a tube with the coupling device according to the present disclosure.

The method comprises connecting the coupling device with its end 10b to a female element. The method also comprises connecting a tube by inserting the tube into the housing along the direction of insertion u, via the ring, and up to engagement with the locking means.

The method further comprises dimensioning the exhaust path to allow the emission of an audible signal with an intensity greater than 80 dB when a fluid leak occurs. As a reminder, this dimensioning is accessible to the skilled person either theoretically, based on the laws of thermodynamics and acoustics, or empirically and notably by carrying out experimental measurements. It is also understood that the dimensioning considered depends on various parameters and notably on the pressure of the fluid, the intensity of the noise level expected in the event of a leak, the fluid considered, etc.

Of course, the present disclosure is not limited to the described embodiments, and it is possible to add variants thereto without departing from the scope of the invention as defined by the claims.

### REFERENCES

[1] WO2021148737A1;
[2] FR3021089A1;
[3] U.S. Pat. No. 10,969,041 B2;
[4] FR3128271 A1.

What is claimed is:

1. A coupling device for a tube, comprising:
a main body defining a rotationally symmetrical housing having an opening for inserting a tube in a direction of insertion, the housing being delimited by an inner surface and comprising a first shoulder forming a widening of the housing in the direction of insertion; and
a retaining ring at least partially inserted into the housing through the opening and comprising, in the direction of insertion, a base and a rotationally symmetrical retaining portion having a diameter smaller than an extent of the base, the retaining portion having a snap-fit collar on a side surface of the retaining portion, the snap-fit collar configured to enable the retaining ring to remain clipped in the housing by way of the snap-fit collar engaging with the first shoulder, the retaining ring defining a channel by which the tube is intended to be inserted into the housing;
wherein the retaining ring is mounted in the housing with axial play that is not zero so as to adopt either a first position or a second position, the first position requiring the collar to bear against a first shoulder in a direction opposite to the direction of insertion, and the second position requiring the base to bear, in the direction of insertion, against an abutment means formed on the main body, escape paths being provided in a space formed between the side surface and the inner surface, and configured to allow a fluid that may be present in a chamber downstream of the retaining ring to escape toward the outside when the ring, under the effect of a pressure that may be exerted by the fluid, is in the first position, the escape paths being configured so that the flow of the fluid in the escape paths generates an emission of a sound wave.

2. The coupling device of claim 1, wherein the escape paths comprise one or more holes formed in the snap-fit collar.

3. The coupling device of claim 1, wherein the escape paths comprise one or more notches formed on an outer contour of the snap-fit collar.

4. The coupling device of claim 1, wherein the escape paths comprise longitudinal grooves formed on the inner surface.

5. The coupling device of claim 1, wherein the coupling device further comprises a guide provided with a sleeve that extends from a free end in the direction of insertion, the guide configured to guide the tube during the insertion of the tube into the housing.

6. The coupling device of claim 1, further comprising locking means arranged downstream of the retaining ring in the housing and configured to engage with a tube that is inserted in the housing.

7. The coupling device of claim 1, wherein the locking means comprises a locking ring.

8. The coupling device of claim 6, wherein a seal is arranged in the housing downstream of the locking means, the seal configured to provide a seal between the inner surface and a side surface of the tube when the tube is inserted into the housing.

9. The coupling device of claim 1, wherein a cleanliness seal is arranged in the channel, the cleanliness seal configured to remove dirt and/or dust that may be present on a side surface of the tube when the tube is inserted into the housing.

10. The coupling device of claim 9, wherein the cleanliness seal is further configured to provide a seal between an inner surface of the retaining portion and the side surface of the tube when the tube is inserted into the housing so as to prevent escape of fluid that may be present in the chamber downstream of the retaining ring when the ring, under the effect of a pressure that may be exerted by the fluid, is in the first position.

11. The coupling device of claim 1, wherein the base is configured to limit dust from entering the housing when the base bears against the abutment means.

12. The coupling device of claim 1, wherein the abutment means are formed by an edge of the main body delimiting the opening of the housing.

13. The coupling device of claim 1, wherein the abutment means are formed by a second shoulder formed on the inner surface.
